(19) United States
(12) Patent Application Publication
(10) Pub. No.: US 2016/0165310 A1
(43) Pub. Date: Jun. 9, 2016

(54) MEDIA CONTENT SELECTION BY SEASON NUMBER

(71) Applicant: EchoStar Technologies L.L.C., Englewood, CO (US)

(72) Inventor: Dawne Belinda Flanagan, Aurora, CO (US)

(73) Assignee: EchoStar Technologies L.L.C.

(21) Appl. No.: 14/562,930

(22) Filed: Dec. 8, 2014

(51) Int. Cl. H04N 21/472; H04N 21/482; H04N 21/4147; H04N 21/433

(52) U.S. Cl. CPC H04N 21/47214; H04N 21/4334; H04N 21/482; H04N 21/4147

(57) ABSTRACT

A media content processing system includes an input device interface configured to receive a user input representing a season selection and a media content receiver configured to receive signals representing season metadata associated with at least one media content instance. A processing device is programmed to extract the season metadata from the signal, compare the season metadata to the user input representing the season selection, and record the at least one media content instance based on the season selection and the season metadata.

### BACKGROUND

Personal video recorders allow users to record content for viewing at a later time. Some personal video recorders allow users to “subscribe” to certain content. That is, the user may identify a particular show and the personal video recorder may record all instances of that show. Alternatively, the user may provide certain keywords, and the personal video recorder may record all shows with those keywords in the title or description. If the user does not wish to record all instances of a particular show, the personal video recorder may allow the user to select only new showings. Therefore, reruns of a show will not be recorded.

### BRIEF DESCRIPTION OF THE DRAWINGS

FIG. 1 illustrates an example media content processing system that records media content based on a user input of a season selection and season metadata.

FIG. 2 is a flowchart of an example process that may be executed by the media content processing system to receive the season selection.

FIG. 3 is a flowchart of an example process that may be executed by the media content processing system to record media content instances in accordance with the season selection.

### DETAILED DESCRIPTION

Personal video recorders that allow users to subscribe to shows typically only allow the user to select whether to record new showings or all showings (i.e., new showings and reruns). Some users may wish to only record showings associated with a particular season, however. A media content processing system that permits a user to schedule recordings of media content associated with a particular season includes an input device interface, a media content receiver, and a processing device. The input device interface is configured to receive a user input representing a season selection. Thus, when scheduling a recording, the user input may indicate the particular season of a media content instance the user wishes to have recorded. The media content receiver is configured to receive signals representing the media content instance. The signals may further include season metadata that links the media content instance to a particular season number, episode number, or both. A processing device is programmed to extract the season metadata from the signal, compare the season metadata to the user input representing the season selection, and record the media content instance if the season selection and the season metadata match.

The elements shown may take many different forms and include multiple and/or alternate components and facilities. The example components illustrated are not intended to be limiting. Indeed, additional or alternative components and/or implementations may be used.

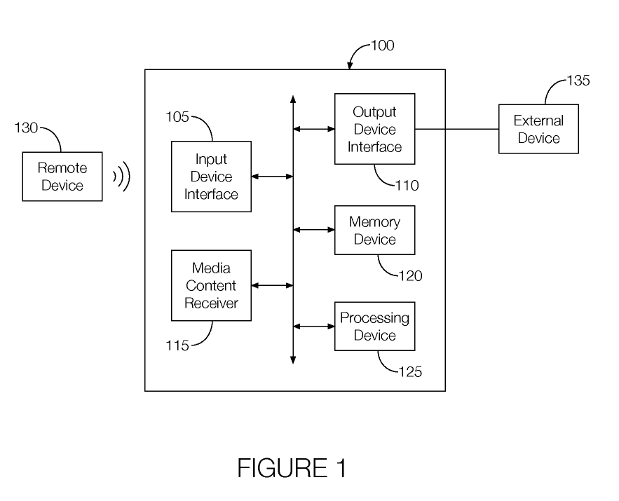

As illustrated in FIG. 1, the media content processing system 100 may include an input device interface 105, an output device interface 110, a media content receiver 115, a memory device 120, and a processing device 125. The media content processing system 100 may be configured to receive, present, and record media content such as television shows, movies, videos, games, music, etc. The media content may be received from a content provider over a telecommunications network. In some possible approaches, the media content processing system 100 may include a set top box, a personal video recorder, a digital media player, or the like.

The input device interface 105 may be configured to receive user inputs transmitted from, e.g., a remote device 130 such as a remote control. The input device interface 105 may be configured to communicate wirelessly with the remote device 130. In one possible approach, the input device interface 105 may include an infrared (IR) receiver, a WiFi receiver, a radio frequency (RF) receiver, or the like. The input device interface 105 may generate a signal in accordance with received user inputs. The signals generated by the input device interface 105 may be transmitted to the processing device 125. Examples of user inputs may include, e.g., a user input to turn on the media content processing system 100, to display a list of media content instances, to display information about each media content instance, and to record a media content instance. As discussed in greater detail below, another user input may include a season selection.

The output device interface 110 may be configured to output media content to an external device 135 such as a television or computer monitor. The output device interface 110 may be configured to transmit media content to the external device 135 according to any number of audio and video communication protocols. For example, the output device interface 110 may comply with the High-Definition Multimedia Interface (HDMI) standard, the Digital Visual Interface (DVI) standard, the Video Graphics Array (VGA) standard, the Composite video standard, the S-Video standard, the Radio Corporation of America (RCA) standard, the Component Video standard, or any other digital or analog audio or video communication standards.

The media content receiver 115 may be configured to receive encoded media content from the content provider, decode the encoded media content, and output the decoded media content to the output device interface 110. The media content receiver 115 may be configured to receive and decode media content in accordance with any number of standards such as the Digital Video Broadcasting—Satellite—Second Generation (DVB-S2) standard. The media content receiver 115 may be configured to comply with other standards such as those developed by the Advanced Television Systems Committee (ATSC).

The memory device 120 may be configured to receive and store data. For example, recorded media content may be stored in the memory device 120. The memory device 120 may be accessible to other components of the media content processing system 100 so that a list of stored media content instances can be presented via the external device 135, selected via a user input, and output to the external device 135 via the output device interface 110. The memory device 120 may include a media content database. The media content database may include a list of media content instances to record as well as criteria for when those media content instances should be recorded. The criteria may indicate whether new showings of a media content instance should be recorded or both new and repeat showings of a media content instance should be recorded.

Other criteria may be associated with metadata such as season metadata—that is, metadata that identifies the media content instance by season, episode, or both—related to each media content instance listed in the media content database. Both the episode and season number may be represented with alphanumeric characters. Examples of season metadata for Season 3, Episode 7 of a media content instance may include “S03E07”, “S307”, “307”, etc. Metadata, including season metadata, may be transmitted with the media content instance from the content provider. In some instances, season metadata may be presented via a user interface before the media content instance is transmitted to the media content receiver 115. This way, the media content processing system 100 will be able to access and consider the season metadata prior to scheduling the media content instance for recording. The season metadata, along with a season selection, may be related to each media content instance, whether recorded or scheduled for recording, listed in the media content database and stored in the memory device 120.

The processing device 125 may be programmed to process user inputs and command other components of the media content processing system 100 to operate in accordance with the user inputs received. For example, when a user wishes to schedule a recording of a media content instance, the processing device 125 may be programmed to extract the season metadata associated with the media content instance from signals received via the media content receiver 115 and prompt the user, via the external device 135, to select whether to schedule all instances, only new instances, or only instances from a particular season or seasons for recording. The prompt may present a list of available seasons, episodes, or both. If the processing device 125 receives a user input selecting a particular season or seasons, the processing device 125 may further prompt the user to select a particular episode or group of episodes. After the criteria for scheduling the recording have been set, the processing device 125 may be programmed to record media content instances in accordance with the user inputs.

For example, the processing device 125 may be programmed to extract season metadata associated with future showings of the media content instance scheduled for recording. The processing device 125 may be programmed to compare the extracted season metadata to the season selection. Again, the season selection may include a particular season, seasons, episode, or episodes, of the media content instance. The season selection may be stored in the media content database in the memory device 120 so the processing device 125 may be programmed to query the media content database for the season metadata associated with the media content instance scheduled for recording. If the season metadata for the future showing of the media content instance matches the season selection, the processing device 125 may be programmed to schedule the media content instance for recording.

Accordingly, the media content processing system 100 may record only those media content instances from a particular season selected by the user.

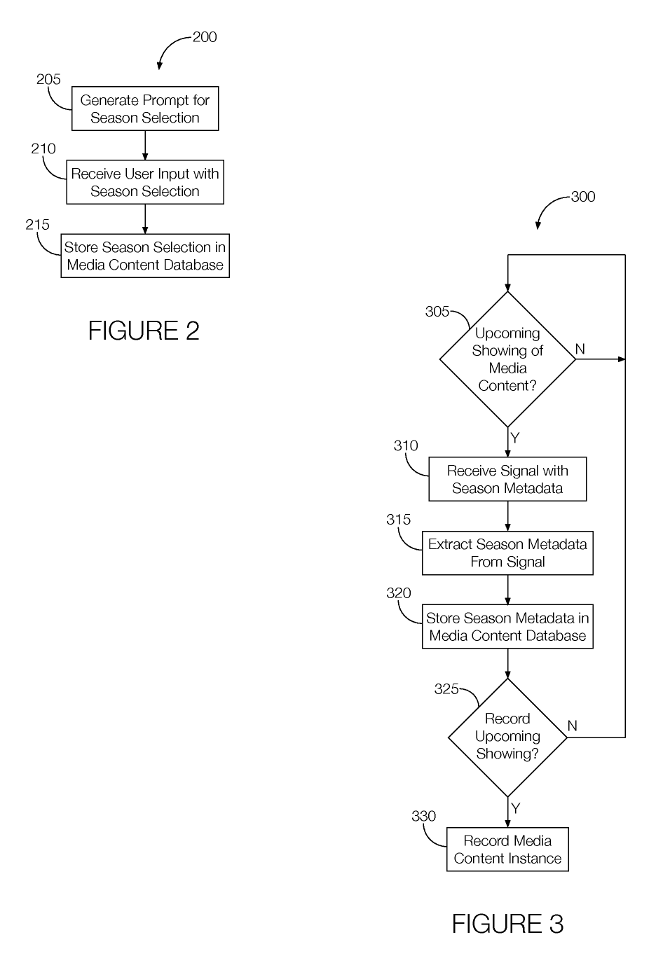

FIG. 2 is a flowchart of an example process 200 that may be executed by the media content processing system 100 to schedule recordings of media content by season. The process 200 may be initiated in response to a user selection to schedule a recording of a media content instance and a user selection indicating that the user wishes to record one or more media content instances appearing in a particular season.

At block 205, the processing device 125 may generate a prompt for the user to select a season. The prompt may be presented via a graphical user interface on the external device 135, and the prompt may present a list of available seasons, episodes, or both, for a particular media content instance.

At block 210, the processing device 125 may receive the user input representing the season selection. In some instances, after receiving the season selection, the processing device 125 may further prompt the user to select a particular episode or group of episodes. Thus, the “season selection” may further include a particular episode or group of episodes.

At block 215, the processing device 125 may store the season selection in the media content database. In the media content database, the season selection may be associated with a particular media content instance or group of media content instances scheduled for future recording.

The process 200 may end after block 215.

FIG. 3 is a flowchart of an example process 300 that may be executed by the media content processing system 100 to record media content instances in accordance with the season selection. The process 300 may be initiated after a media content instance has been scheduled for recording with a particular season selection.

At decision block 305, the processing device 125 may determine whether a media content instance scheduled for recording will be shown in the near future (e.g., within the next two weeks or so). For instance, the processing device 125 may search for the media content instance in a guide. If the media content instance appears in the guide, the process 300 may continue at block 310. Otherwise, the process 300 may return to block 305 until a media content instance scheduled for recording appears.

At block 310, the processing device 125 may receive a signal representing the season metadata associated with one of the media content instances scheduled for recording. As discussed above, season metadata may identify the media content instance by season, episode, or both. Both the episode and season number may be represented with alphanumeric characters. Examples of season metadata for Season 3, Episode 7 of a media content instance may include “S03E07”, “S307”, “307”, etc.

At block 315, the processing device 125 may extract the season metadata from the signal. The season metadata may be extracted and converted to a form that can be stored in the media content database.

At block 320, the processing device 125 may store the season metadata in the media content database. The season metadata may be included in the media content database in a way that relates the season metadata to a particular media content instance scheduled for recording.

At decision block 325, the processing device 125 may determine whether to record the upcoming showing of the media content instance. For example, the processing device 125 may compare the season metadata to the season selection. That is, the processing device 125 may query the media content database for the season metadata, the season selection, or both, and determine whether the season selection includes the season or episode represented by the season metadata. The processing device 125 may determine that the upcoming media content instance should be recorded if the season metadata matches the season selection. In such instance, the process 300 may continue at block 330. Otherwise, the process 300 may return to block 305.

At block 330, the processing device 125 may record the media content instance. Recording the media content instance may include scheduling the media content instance for recording at the time of the next showing and, when the media content instance is shown, storing the media content instance in the memory device 120.

The process 300 may end after block 330. Alternatively, the process 300 may return to block 305 to await additional season metadata for scheduled recordings.

In general, the computing systems and/or devices described may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A media content processing system comprising:
an input device interface configured to receive a user input representing a season selection;
a media content receiver configured to receive season metadata associated with at least one media content instance;
a processing device programmed to extract the season metadata from the signal, compare the season metadata to the user input representing the season selection, and record the at least one media content instance based on the season selection and the season metadata.

2. The media content processing system of claim 1, further comprising a memory device configured to store the at least one media content instance recorded.

3. The media content processing system of claim 2, wherein the memory device is configured to store a media content database.

4. The media content processing system of claim 3, wherein the media content database includes the season metadata associated with each media content instance.

5. The media content processing system of claim 4, wherein the processing device is programmed to query the media content database for the season metadata.

6. The media content processing system of claim 1, wherein the processing device is programmed to generate a prompt for the season selection.

7. The media content processing system of claim 6, wherein the prompt includes a list of seasons based on the season metadata.

8. The media content processing system of claim 6, wherein the processing device is programmed to receive the season selection in response to the prompt.

9. The media content processing system of claim 1, further comprising an output device interface configured to output the at lest one media content instance to a display device.

10. A media content processing system comprising:
a processing device programmed to generate a prompt for a season selection associated with a media content instance;
an input device interface configured to receive a user input representing the season selection; and
a media content receiver configured to receive signals representing season metadata associated with the media content instance;
wherein the processing device is programmed to extract the season metadata from the signal, compare the season metadata to the season selection, and record the media content instance based on the season selection and the season metadata.

11. The media content processing system of claim 10, further comprising a memory device configured to store the media content instance recorded.

12. The media content processing system of claim 11, wherein the memory device is configured to store a media content database.

13. The media content processing system of claim 12, wherein the media content database includes the season metadata associated with the media content instance.

14. The media content processing system of claim 13, wherein the processing device is programmed to query the media content database for the season metadata.

15. The media content processing system of claim 10, wherein the prompt includes a list of seasons based on the season metadata.

16. The media content processing system of claim 10, wherein the processing device is programmed to receive the season selection in response to the prompt.

17. The media content processing system of claim 10, further comprising an output device interface configured to output the media content instance to a display device.

18. The media content processing system of claim 17, wherein the output device interface is configured to output the prompt to the display device.

19. A method comprising:
generating a prompt for a season selection associated with a media content instance;
receiving a user input representing the season selection;
receiving a signal representing season metadata associated with a media content instance;
extracting the season metadata from the signal;
comparing the season metadata to the season selection; and
recording the media content instance based on the season selection and the season metadata.

20. The method of claim 19, wherein recording the media content instance includes storing the media content instance in a memory device with a media content database, the media content database including the season metadata associated with the stored media content instance.
